(19) United States
(12) Patent Application Publication
(10) Pub. No.: US 2001/0024329 A1
(43) Pub. Date: Sep. 27, 2001

(54) Beamsplitter

(76) Inventor: Jorg Dreistein, Aalen (DE)

Correspondence Address: M. Robert Kestenbaum, 11011 Bermuda Dunes NE, Albuquerque, NM, 87111, US

(21) Appl. No.: 09/759,956

(22) Filed: Jan. 11, 2001

(30) Foreign Application Priority Data
Jan. 11, 2000 (DE) 100 00 665.5

(51) Int. Cl. G02B 27/10; G02B 27/14; G02B 27/12

(52) U.S. Cl. 359/629; 359/627; 359/633; 359/636; 359/639

(57) ABSTRACT

A beamsplitter, including numerous reflecting surface segments, by which a predetermined portion of an incident radiation is coupled-out, the reflecting surface segments being arranged at an angle to the incident radiation, wherein partially reflecting surface segments are provided as the reflecting surface segments, and are aligned mutually parallel and are arranged laterally displaced from each other in a plane arranged perpendicular to the incident radiation.

### CROSS-REFERENCES TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

The invention relates to a beamsplitter, and more particularly, to a beamsplitter having a plurality of reflecting surface segments, by which a predetermined portion of an incident radiation is coupled-out, the reflecting surface segments being arranged at an angle to the incident radiation.

### FIELD OF THE INVENTION

Beamsplitters are described on pages 182-184 in chapter 58 of the technical book “Constructional Elements of Optics” by Naumann and Schröder (Hansa-Verlag, sixth edition). Beamsplitters can be divided into geometrical and physical beamsplitters. In geometrical beamsplitters, the incident rays are divided, in dependence on the point at which they strike the beamsplitter, into different emergent pencils of rays. A flat plate on which strip-shaped mirrors are set up is shown, for example, as a geometrical beamsplitter. This flat plate is arranged at an angle of 45° to the incident radiation, so that the radiation striking and reflected at the mirror regions is propagated perpendicularly to the incident radiation, while the radiation striking the flat plate in the non-mirrored regions leaves the beamsplitter, displaced laterally in relation to the incident radiation because of the refraction at the front and back sides, in dependence on the optical density of the flat plate.

Furthermore, grooved mirrors are known as beamsplitters; they have reflecting surface segments with opposed slope on the side toward the incident light beam, thus forming a serrated surface. The radiation striking this surface is reflected in different spatial directions, the radiation striking the first mirror segments with a first surface inclination being reflected in a first spatial direction, and that striking the second mirror surfaces with an opposed slope or surface inclination being reflected in a second spatial direction predetermined by the surface segments. The angle between these pencils of rays of the reflected radiation which are formed corresponds to the angle at which the first and second surface segments are arranged relative to each other.

Furthermore, as a geometrical beamsplitter, a beamsplitter is knows which is formed from two rhomboid prisms with opposed spatial alignment, by means of which a symmetrical aperture division is provided.

With these geometrical beamsplitters, it is disadvantageous that no proportional division of the incident radiation is possible which represents a proportional average over the radiation intensity.

The physical beamsplitters have partially reflecting surfaces at which a predetermined portion of the incident radiation is reflected, while the remaining portion, apart from absorption losses, passes unhindered through this partially reflecting layer. These physical beamsplitters are arranged at an angle of 45° to the incident radiation, for a coupling-out of a portion of the incident light perpendicularly to the incident beam.

A large constructional space is required by the beamsplitter, due to the arrangement of the partially reflecting layer at an angle of 45° to the incident radiation.

Beamsplitters are frequently used in objectives, particularly for semiconductor lithography, in order to determine the radiation intensity of the transmitted radiation from the radiation intensity of the coupled-out radiation, and thus to determine the exposure intensity of the respective wafer or film.

With objectives which are becoming more and more compact, and with higher requirements on these objectives, particularly for objectives for semiconductor lithography, it is however precisely the axial constructional space which is particularly restricted. On the other hand, it is imperatively required to exactly determine the exposure dose to within 1% for semiconductor lithography.

### DISCUSSION OF RELEVANT ART

From European Patent Document EP 484 801 A2, a geometrical beamsplitter is known by means of which an image is decomposed into partial segments, which are recorded by means of CCD arrays, which are obtainable as standard components. These recorded beam segments are assembled into a whole image. Such a beamsplitter is in particular used when a recording of the image is not possible, because of its size, by means of a CCD obtainable as a standard component, or another recording unit obtainable as a standard component.

### SUMMARY OF THE INVENTION

The invention has as its object to provide a beamsplitter whose extent in the axial direction is minimized. The invention has as a further object to develop a beamsplitter such that the data of the predetermined coupled-out portion can be predetermined with increased accuracy.

The object of the invention is attained by providing partially reflecting surface segments on beamsplitters having numerous reflecting surface segments, and arranging these, laterally displaced with respect to each other, to form a plane arranged perpendicular to the incident light ray, the partially reflecting surface segments being arranged mutually parallel. A beamsplitter is provided which is of extremely short dimension in the axial direction and by means of which a predetermined portion of the radiation striking the beamsplitter is coupled out perpendicular to the incident radiation. With perpendicular coupling-out, it is possible to detect the intensity of the coupled-out radiation by means of a detector arranged parallel to the beam path.

It has been found to be advantageous to arrange the partially reflecting surface segments parallel to each other at a non-zero constant spacing. The spacing is preferably chosen such that the whole of the radiation striking the beamsplitter must pass through, or be reflected at, a respective partially reflecting surface, with the partially reflecting surface segments overlapping each other only minimally or not at all.

It has been found to be advantageous that the partially reflecting surface segments are supported by planar transparent support segments which are arranged at an angle of 45° to the incident radiation. The remaining boundary surfaces of the transparent support surfaces not arranged at an angle of 45° to the incident radiation are preferably arranged perpendicularly to the incident radiation. It is thereby ensured that the radiation striking the beamsplitter passes in a straight line through the partially reflecting surface of the beamsplitter during transmission. If the incident radiation strikes the beamsplitter at a small angle, the resulting deviation from a linear path can be tolerated in most cases of application.

Such planar support segments which are provided with partially reflecting surface segments can in particular be produced in a cost-effective manner by vapor deposition onto a transparent support, such as e.g. a glass support, and a subsequent cutting process.

It has furthermore been found to be advantageous to incorporate, or apply, partially reflecting surface segments to a transparent carrier, for example, by an etching process. Such partially reflecting layers which are arranged in a transparent support can be cost-effectively produced by means of known etching processes.

It has been found to be advantageous in some cases of application to deposit preferably planar partially reflecting surface segments on a transparent support. Such partially reflecting surface segments are particularly to be formed by means of a lacquer coating which is hardened by exposure in partial regions. It is possible by a corresponding choice of the lacquer for the partially reflecting surface segments formed to be partially reflecting only for given wavelengths and transmissive in operation in the remaining wavelengths.

In a further advantageous embodiment, a transparent support is provided with a staircase structure on the side facing the incident radiation. This staircase structure has first surface segments that are arranged at an angle of 45° to the incident radiation. These first surface segments are connected together by second surface segments which are arranged parallel to the incident radiation, at least the first surface segments being partially reflecting. A covering support is to be associated with the transparent support having a staircase structure, and is provided on the side turned away from the incident radiation with a reciprocal staircase structure. With such an arrangement, the partially reflecting surface segments can be arranged both on the cover support and also on the glass support. The cover support is preferably positively connected to the transparent support, so that a beamsplitter formed by these two elements has surfaces, on the side toward the incident radiation and on the side turned away from the incident radiation, which are preferably arranged perpendicularly to the incident radiation, so that the incident radiation is not diffracted at these surfaces.

A beamsplitter having planar surfaces can easily be cleaned, particularly before mounting. Also, such beamsplitters are more stable and can be more easily packed because of their geometrical shape.

It has been found to be advantageous to provide the surfaces that are perpendicular to the incident radiation with an antireflective coating. An undesired reflection of the radiation incident on these surfaces can thereby be prevented, or at least reduced, and the radiation losses are thereby reduced.

An embodiment has been found to be particularly advantageous in which the partially reflecting surface segments are arranged coaxial to a focus which is arranged outside the beam of the incident radiation and in a radial continuation to the beamsplitter. This arrangement is particularly of advantage when only a very small portion of the incident light is coupled-out for the determination of the radiation intensity. The measurement accuracy can thereby be raised, since the focusing ensures that the coupled-out radiation is completely sensed by the detector. The beam intensity at the focus is thus quite high, so that interference, such as radiation from the surroundings, is not so important. Measuring inaccuracies of the detector are not so important. If only a small portion of the input intensity of the incident radiation is required for the determination of the illumination intensity, the input intensity for a required resultant illumination intensity can correspondingly be kept small, which is advantageous for the energy balance. In addition, a detector having a small detector surface can be used. Also, no separate optics need to be provided for focusing the coupled-out light; this is advantageous as regards costs.

By the measure of providing a support with a microstructure that has periodicity intervals, a beamsplitter is provided with a further shortening of construction in the axial direction. In dependence on the relationship of the selected structural magnitudes of the microstructure to the wavelength used for illumination, diffraction phenomena can be brought into play in a targeted manner for a coupling-out of the predetermined portion of the light incident on the beamsplitter and for a determination of the light intensity being transmitted. It has been found to be advantageous to provide as the support a plate with surfaces directed perpendicular to the incident radiation, the microstructure being arranged on the front side of the plate.

It has been found to be advantageous to select the periodicity intervals of the microstructure such that the diffraction image resulting from these periodicity intervals has a diffraction maximum of higher order, with its radiation striking the surface of the plate turned away from the incident radiation at an angle at which total reflection occurs and thus the radiation of the first diffraction maximum is conducted under condition of total reflection to the lateral boundary edge of the plate, and is emergent there. The plate thus functions as a beam guide. A diffraction order of the smallest possible order is predetermined, since it still has a relatively high intensity, which makes possible a very exact determination of the beam intensity being transmitted. However, the radiation of a higher diffraction order could also be coupled-out, but higher radiation losses then have to be taken into account.

The intensity of the incident radiation or of the radiation passing through the beamsplitter can be determined by sensing the radiation intensity emerging from this plate edge.

Further advantageous measures are described in the description of preferred embodiments.

### BRIEF DESCRIPTION OF THE DRAWINGS

The invention is described in more detail hereinafter with the aid of embodiments, in which:

FIG. 1 shows a beamsplitter with divider segments of parallelogram shape;

FIG. 2 shows a graphical illustration of the propagation of radiation;

FIG. 3 shows a beamsplitter that includes a staircase structure;

FIG. 4 shows a beamsplitter with partially reflecting surfaces arranged coaxial with a focus;

FIG. 5 shows a beamsplitter with microstructure on the front side;

FIG. 6 shows an enlarged illustration of the microstructure; and

FIG. 7 shows the critical angle for the transition from glass to air.

### DETAILED DESCRIPTION OF PREFERRED EMBODIMENTS

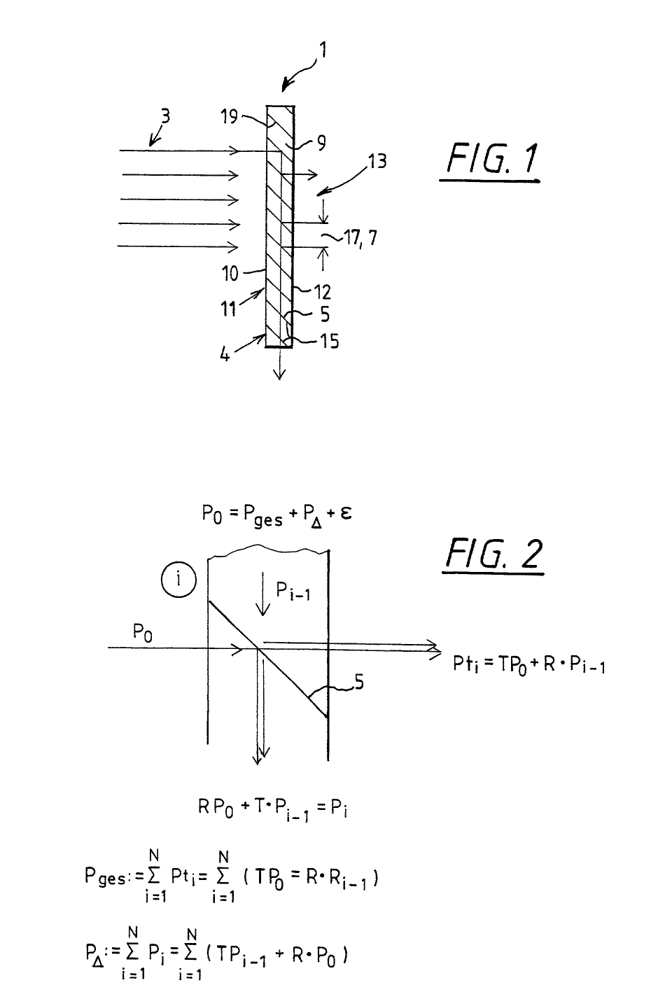

The beamsplitter 1 shown in FIG. 1 has partially reflecting surface segments 5, which are arranged at an angle of 45° to the incident radiation 3. These partially reflecting surface segments 5 are arranged, laterally displaced relative to each other, in a plane 4 arranged perpendicular to the incident radiation 3, the partially reflecting surface segments 5 being themselves arranged parallel to each other at a constant spacing 7. These partially reflecting surface segments 5 are supported by planar, transparent support segments 9. These support segments 9 have boundary surfaces 11, 13 running perpendicular to the incident radiation 3, respectively one on the side 10 facing the incident radiation 3 and on the side 12 turned away from the incident radiation 3. These boundary surfaces can be provided with an anti-reflective coating to reduce radiation losses due to scattering.

For the production of such a beamsplitter 1, transparent support segments 9, already made in a parallelogram shape, can be provided with a partially reflecting layer 19, for example by means of vapor deposition, by means of which the partially reflecting surface segments 5 are formed. This partially reflecting layer 19 can also be applied to a transparent support 21, such as for example a glass plate, from which the transparent support segments 9 are then cut. It can also be provided that the transparent support segments 9 are provided with a partially reflecting layer 19, both on a front side and on a back side. These transparent support segments 9 are joined together, at the surface provided with the partially reflecting layer 19, and in the appropriate circumstances when only one surface is provided with a partially reflecting layer, with the surface 15 parallel to them, of the following transparent support segment 9, so that a plane surface is formed by the boundary surfaces 11, 13 respectively facing toward and turned away from the incident radiation 3.

The manner in which the intensity of the radiation is divided due to the partially reflecting surface segments 5 is explained in more detail with the aid of FIG. 2. Radiation 3 with intensity Po strikes the i-th partially reflecting surface segment 5, a portion R of the incident radiation 3 being reflected at the same, and the portion T being transmitted. Since the partially reflecting surface segments 5 are arranged parallel, mutually displaced at the spacing 17 from each other, the radiation R*Po remaining in the beamsplitter 1 strikes the back side of the next partially reflecting layer 5, to which the numbering i+1 is assigned. A portion R of the intensity of this radiation is reflected and emerges, in common with the radiation intensity portion T*Po transmitted at this partially reflecting surface segment 5, from the beamsplitter 1. The remaining portion T*Pi is transmitted and is summed with the radiation portion R*Po of the incident radiation 3 reflected at this partially reflecting surface segment 5 numbered i+1. The portion of transmitted radiation is obtained by summing over the number of partially reflecting surface segments from 1 through N. Furthermore, the portion of the incident radiation which propagates in the beamsplitter perpendicularly to the incident radiation and leaves the beamsplitter laterally, perpendicular to the incident radiation, is obtained by summing over the number N of partially reflecting surface segments 5. The portion of the coupled-out radiation is denoted by P_{Ä} (see FIG. 3). By a calibration measurement, the portion å of scattering losses can be determined; it depends on the number N of partially reflecting surface segments 5.

The beamsplitter 1 shown in FIG. 3 differs solely in the construction of the support structure on which the partially reflecting surface segments 5 are mounted, the partially reflecting surface segments 5 being arranged in the same way, seen from the incident radiation 3. These partially reflecting surface segments 5 are however supported by a glass support 21 which has a staircase structure 23, having surface segments 25 with two orientations, on the side facing the incident radiation 3. First surface segments 27 are arranged at an angle of 45° to the incident radiation 3, and second surface segments 29 by means of which the first surface segments 29 are connected together are aligned parallel to the incident radiation 3, forming a staircase structure. The partially reflecting surface segments 5 are supported by the first surface segments 27.

In the embodiment shown, a cover support 22 is associated with the transparent support 21, and has on the side turned away from the incident radiation 3 a staircase structure 24 formed in the opposite sense to the staircase structure 23 of the transparent support 21; the first surface segments 27 can likewise be provided with a partially reflecting layer 19. Such a layer can be applied by vapor deposition.

A plate 43 with parallel surfaces is formed by joining together the transparent cover support 22 and the support 21, with a layer including partially reflecting surface segments 5 integrated into it. It can be provided that the cover support 22 and glass support 21 are joined together with a cemented joint. Such an integrated partially reflecting layer can also be formed in a transparent support by an etching process.

Scattering losses can be reduced in this embodiment also, by the provision of an anti-reflective layer on the surface 45 arranged perpendicular to the incident radiation 3.

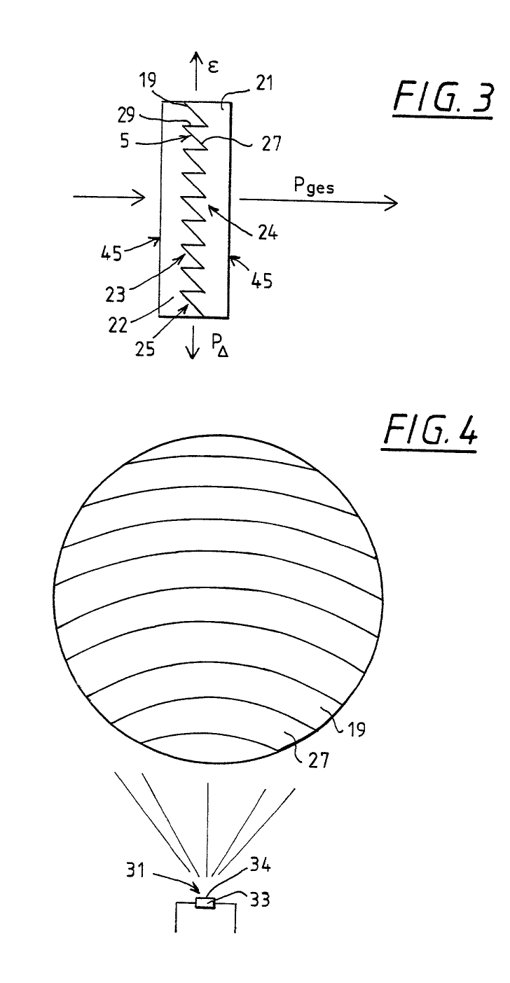

The embodiment shown in FIG. 4 is shown from the viewpoint of the incident radiation 3. The partially reflecting surface segments 5 arranged at an angle of 45° to the incident radiation 3 are arranged for focusing the portion P_{Å} to be coupled-out, coaxially to a focus 31 which is arranged outside the beam path of the incident radiation 3. A detector 33 is provided at the focus 31, for the detection of the intensity of the coupled-out portion P_{Ä} of the incident radiation 3. This radiation, apart from minimal scattering losses, is completely detected by the detector. A detector 33 having a detector surface 34 of small extent is sufficient for sensing this intensity.

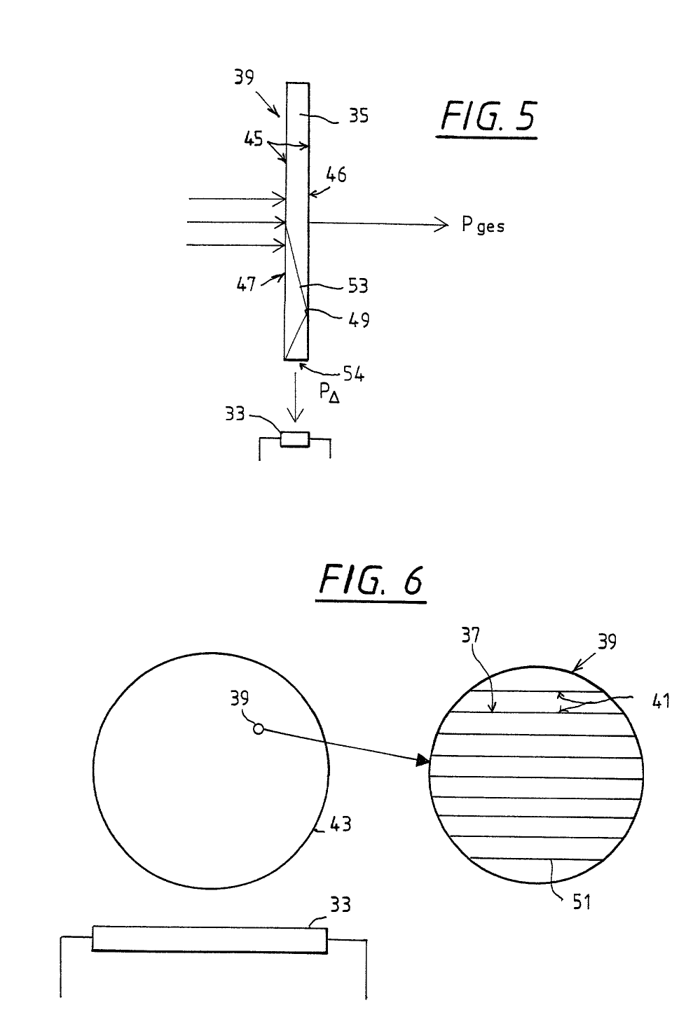

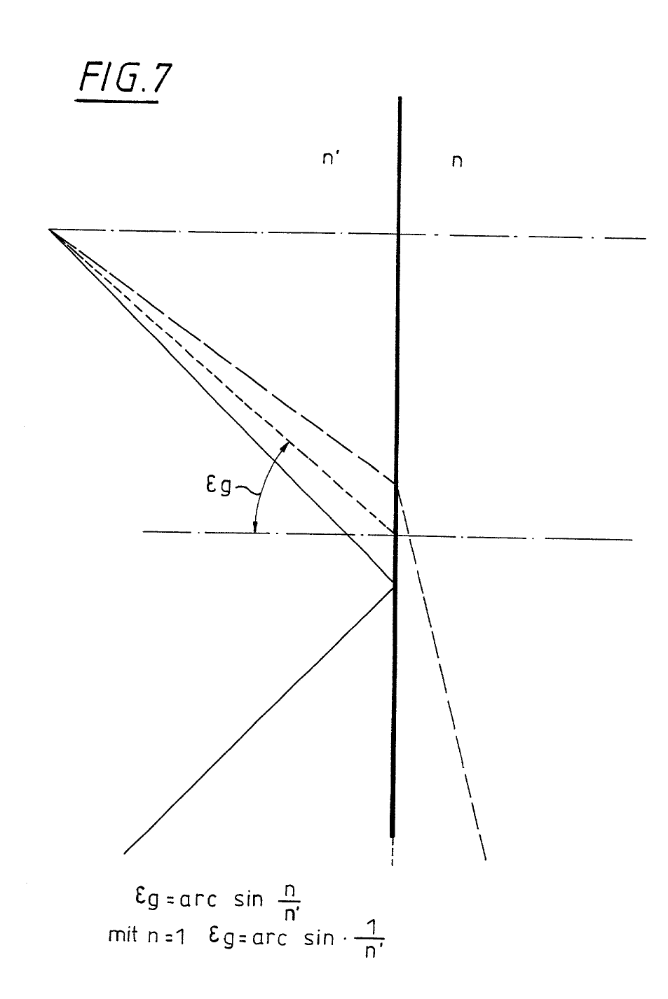

An embodiment of a beamsplitter 1 having a surface 45 provided with a microstructure 39 as a periodic structure 37 is described with the aid of FIGS. 5 and 6. The periodicity intervals 41 of the microstructure 39 are selected in dependence on the wavelength at which the beamsplitter is to be used, so that a diffraction image results from the provision of the microstructure 39. This microstructure 39 is applied to a plate 43, e.g. by means of lacquer coating or by an etching process. This microstructure has surfaces 46, 47 which are mutually parallel and are aligned perpendicularly to the incident radiation 3, a diffraction maximum of higher order striking the surface 46 on the side turned away from the incident radiation 3 at a shallow angle such that this radiation remains by total reflection within the plate 43, which thus acts as a light guide 49. The end surface 54, and particularly its extent, is adapted to the detector used, so that focusing optics are omitted.

A possible microstructure 39 is shown in FIG. 6; the lines 51, arranged mutually parallel at a spacing 41, are shown greatly enlarged. This spacing 41 is at the same time the periodicity interval 41 of the periodic structure 37. For diffraction phenomena to arise, the periodicity of the microstructure 39 must be selected about in the region of the wavelength of the incident radiation.

For perpendicular incidence,

g=(ë/n)·cos á,

where

g=lattice constant

ë=wavelength in air

n=refractive index of glass

cos á=diffraction angle in the lattice support.

For the use of radiation of wavelength 193 nm and use of a lattice with 1,000 lines per millimeter, the associated diffraction orders are given by the angles set out in Table 1.

The critical angle Eg for total reflection results from:

Eg=arcsin (n/n′);

With n=1, Eg=arc sin (1/n′),

where n is the refractive index of air and n′ is the refractive index of the support used (here, quartz glass with n′=1.6).

Consequently the critical angle Eg in this embodiment is situated at 38.68°, for diffraction in glass. Thus the sixth diffraction order is coupled out by means of total reflection, due to the microstructure.

It can also be provided to impress a preferred direction on the diffraction orders by means of a specially shaped embodiment of the individual grid lines, for example, triangular grooves, so that already lower diffraction orders are coupled-out by total reflection. It can also be provided to provide a plate with a microstructure on only a partial region.

TABLE 1

| Diffraction Order | Angle in ° |
|---|---|
| 1 | 6.9 |
| 2 | 13.9 |
| 3 | 21.2 |
| 4 | 28.8 |
| 5 | 37.1 |
| 6 | 46.3 |

The power coupled out is given by:

Pₙ=R·Pₒ·(1−Tⁿ)/(1−T)

List of Reference Numbers

(1) beamsplitter

(3) incident radiation

(4) plane

(5) partially reflecting surface segment

(7) spacing

(9) transparent support segment

(10) facing side

(11) light beam, facing boundary surface

(12) turned away side

(13) radiation, turned away boundary surface

(15) plane-parallel surface

(17) spacing

(19) partially reflecting layer

(21) transparent support

(22) cover support

(23) staircase structure

(24) opposite sense staircase structure

(25) surface segments

(27) first surface segment

(29) second surface segment

(31) focus

(33) detector

(34) detector surface

(35) support

(37) periodic structure

(39) microstructure

(41) periodicity interval

(43) plate

(45) perpendicular surface

(46) surface (back side)

(47) front side

(49) beam guide

(51) lines

(53) angle

(54) end surface

I claim:

1. A beamsplitter, including a plurality of reflecting surface segments, by which a predetermined portion of an incident radiation is coupled-out, the reflecting surface segments being arranged at an angle to the incident radiation, wherein partially reflecting surface segments are provided as the reflecting surface segments, and are aligned mutually parallel and are arranged laterally displaced from each other in a plane arranged perpendicularly to the incident radiation.

2. The beamsplitter according to claim 1, wherein the partially reflecting surface segments are arranged mutually parallel at a constant spacing that is not zero.

3. The beamsplitter according to claim 1, wherein the partially reflecting surface segments are arranged at an angle of 45° to the incident radiation.

4. The beamsplitter according to at least claim 1, wherein the partially reflecting surface segments are introduced into a transparent support, preferably by etching.

5. The beamsplitter according to claim 4, wherein the partially reflecting surface segments are introduced by etching.

6. The beamsplitter according to claim 1, wherein the partially reflecting surface segments are deposited or mounted on a transparent support.

7. The beamsplitter according to claim 6, wherein the transparent support comprises a planar support.

8. The beamsplitter according to claim 1, wherein the partially reflecting surface segments are supported by planar, transparent support segments that are arranged at an angle of 45° to the incident radiation and have boundary edges at a side facing and a side turned away from the incident radiation that run perpendicular to the incident radiation.

9. The beamsplitter according to claim 1, wherein the transparent support segments have two parallel surfaces at a spacing, wherein at least one of these surfaces is provided with a partially reflecting layer forming a partially reflecting surface segment, and the transparent support segments are connected together over the whole extent of this surface.

10. The beamsplitter according to claim 1, wherein the partially reflecting surface segments are supported by a transparent support that has a surface provided with a staircase structure that has first surface segments arranged at an angle of 45° to the incident radiation and has second surface segments respectively connecting the first surface segments and arranged parallel to the incident radiation.

11. The beamsplitter according to claim 6, wherein the transparent support is connected to a transparent cover support provided on a side facing the glass support with a staircase structure that has the opposite sense to the staircase structure of the transparent support and which in its turn can likewise be provided with partially reflecting surface segments.

12. The beamsplitter according to claim 1, wherein the partially reflecting surface segments are arranged coaxial to a focus that is arranged outside the beam of the incident radiation.

13. The beamsplitter according to claim 1, and having a support provided with a periodic structure, wherein the periodic structure has a microstructure with a periodicity interval.

14. The beamsplitter according to claim 13, wherein the microstructure is supported by a support in the form of a plate with surface aligned perpendicular to the incident radiation, the microstructure being applied to the side facing the incident radiation.

15. The beamsplitter according to claim 13, wherein the radiation of a higher order diffraction maximum strikes the surface of the plate turned away from the incident radiation at an angle at which total reflection occurs and the plate thus functions as a beam guide.

16. The beamsplitter according to claim 13, wherein the support is a plate with surface aligned perpendicular to the incident light beam and provided with a microstructure on a surface turned away from the incident light beam.

17. The beamsplitter according to claim 13, wherein the microstructure has mutually parallel lines that are aligned parallel to a detector surface.

18. The beamsplitter according to claim 13, wherein the periodicity interval is determined by the spacing of the lines.

19. The beamsplitter according to claim 4, wherein at least one surface of the surfaces running perpendicular to the incident radiation is provided with an anti-reflective coating.
